(19) United States
(12) Patent Application Publication
(10) Pub. No.: US 2004/0212931 A1
(43) Pub. Date: Oct. 28, 2004

(54) Head stopper, magnetic disc apparatus, and in-vehicle electronic equipment

(75) Inventor: Hiromichi Takami, Ome-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/800,971

(22) Filed: Mar. 16, 2004

(30) Foreign Application Priority Data
Apr. 25, 2003 (JP) 2003-121581

(51) Int. Cl. G11B 5/55

(52) U.S. Cl. 360/265.1

(57) ABSTRACT

A magnetic disc apparatus includes a magnetic disc, a head having a read element reading information from the magnetic disc, and a head stopper limiting a moving range of the head and formed of a resin containing a hydrolyzable group in an amount not more than 0.7 mole per 100 g.

### CROSS-REFERENCE TO RELATED APPLICATIONS

This application is based upon and claims the benefit of priority from prior Japanese Patent Application No. 2003-121581, filed Apr. 25, 2003, the entire contents of which are incorporated herein by reference.

### BACKGROUND OF THE INVENTION

1. Field of the Invention

The present invention relates to a head stopper limiting the moving range of a head having a read element reading information from a recording medium, and to a magnetic disc apparatus and in-vehicle electronic equipment including the head stopper.

2. Description of the Related Art

In recent years, a magnetic disc apparatus and an optical disc apparatus, which are used in a personal computer or a server, have come to be mounted in an automobile. In this connection, durability under severer conditions has come to be required for the magnetic disc apparatus and the optical disc apparatus. An example of the required durability is 1,000 hours, or 3,000 hours in some cases, under the temperature of 80° C. and the relative humidity of 85%.

A head stopper (or a damper) is a member that gives rise to a problem in the durability in the case where the magnetic disc apparatus or the optical disc apparatus is used under the severe conditions exemplified above. The head stopper is a member for limiting the moving range of a head having a read element reading information recorded in a recording medium.

For example, polyurethane was conventionally used as a material for the head stopper (or damper) in the magnetic disc apparatus (see Japanese Patent Disclosure (Kokai) No. 6-119,726 and Japanese Patent No. 2,634,367). However, if the magnetic disc apparatus is exposed to such an environment as the temperature of 80° C. and the relative humidity of 85% for 1,000 hours, the head stopper made of polyurethane is hydrolyzed so as to be liquefied.

As described above, if the conventional head stopper is left to stand under an environment of a high temperature and a high relative humidity, the head stopper is deteriorated into a liquefied state, resulting in failure to perform the intended purpose.

### BRIEF SUMMARY OF THE INVENTION

According to an aspect of the present invention, there is provided a head stopper configured to limit a moving range of a head having a read element reading information from a recording medium, the head stopper being formed of a resin containing a hydrolyzable group in an amount not more than 0.7 mole per 100 g.

A magnetic disc apparatus according to another aspect of the present invention comprises: a magnetic disc; a head having a read element reading information from the magnetic disc; and a head stopper configured to limit a moving range of the head and formed of a resin containing a hydrolyzable group in an amount not more than 0.7 mole per 100 g.

In-vehicle electronic equipment according to another aspect of the present invention comprises: a head having a read element reading information from a disc recording medium; and a head stopper configured to limit a moving range of the head and formed of a resin containing a hydrolyzable group in an amount not more than 0.7 mole per 100 g. The in-vehicle electronic equipment includes, for example, an optical disc apparatus.

### BRIEF DESCRIPTION OF THE SEVERAL VIEWS OF THE DRAWING

FIG. 1 is a plan view showing the magnetic disc apparatus including the head stopper according to an embodiment of the present invention;

FIG. 2 is a plan view showing the magnetic disc apparatus including the head stopper according to an embodiment of the present invention; and

FIG. 3 is a perspective view showing the optical disc apparatus including the head stopper according to another embodiment of the present invention.

### DETAILED DESCRIPTION OF THE INVENTION

In the embodiments of the present invention, a hydrolyzable group contained in a resin forming a head stopper means such a group as carboxylic ester, amide, urethane, phosphoric ester, and sulfonic ester.

In the embodiments of the present invention, the resin forming the head stopper contains a hydrolyzable group in an amount not more than 0.7 mole per 100 g of the resin. The head stopper of the particular material exhibits durability exceeding 1,000 hours under the temperature of 80° C. and the relative humidity of 85%. Further, where durability exceeding 3,000 hours is required under the temperature of 80° C. and the relative humidity of 85% or where the head stopper is used under an acidic gaseous atmosphere, the resin forming the head stopper preferably contains a hydrolyzable group in an amount not more than 0.05 mole per 100 g of the resin.

In the embodiments of the present invention, the resin forming the head stopper is selected from the group consisting of a polyester elastomer, a styrene-ethylene-butylene-styrene block copolymer (SEBS), and an elastomer-added polyacetal (or polyoxymethylene; POM).

The polyester elastomer includes, for example, PELPRENE P-type available from Toyobo Co., Ltd. The styrene-ethylene-butylene-styrene block copolymer (SEBE) includes one available from Aron Kasei Co., Ltd. The elastomer-added polyacetal (or polyoxymethylene; POM) includes TENAC available from Asahi Kasei Corporation.

PELPRENE P-type is represented by the chemical formula given below:

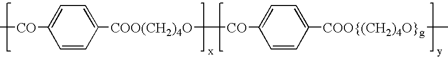

In the chemical formula, the polyester block on the left side is a hard segment, and the polyether block on the right side is a soft segment. In the polyester elastomer, the amount of the hydrolyzable group can be controlled by the proportion of the polyether block, which is an elastomer component.

In the embodiments of the present invention, the resin forming the head stopper may contain inorganic filler.

In the embodiments of the present invention, the head stopper preferably exhibits rebound resilience not higher than 60, which is measured in conformity with JIS K6255. The head stopper satisfying the particular rebound resilience can be used suitably as an outer stopper for limiting the movement of the head to an outer position across an unloading area from a loading position on the magnetic disc. The reason for the particular use of the head stopper will be described herein later in detail.

Embodiments of the present invention will now be described with reference to the accompanying drawings.

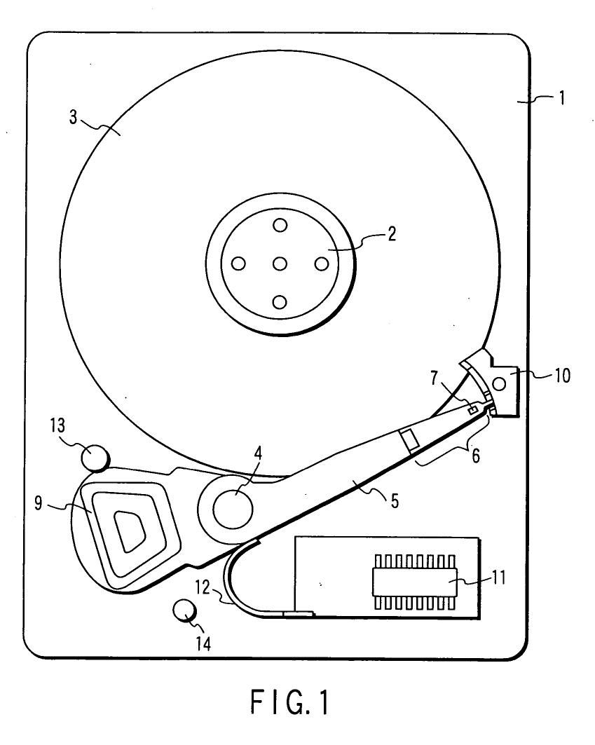

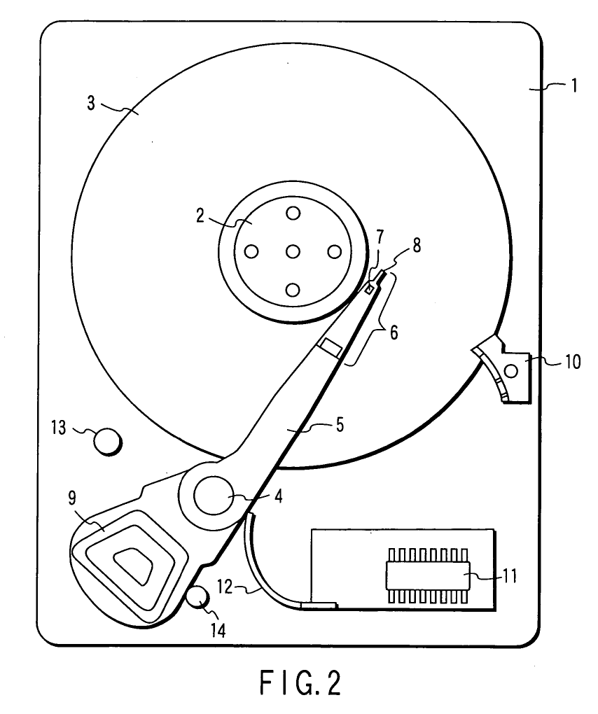

FIGS. 1 and 2 are plan views each showing the magnetic disc apparatus including a head stopper according to an embodiment of the present invention. FIG. 1 shows a state that the movement of the head is limited by means of the outer stopper, and FIG. 2 shows a state that the movement of the head is limited by means of the inner stopper.

The magnetic disc 3 is clamped with the damper 2 of a spindle motor mounted on the base 1. The arm 5 is fitted to the pivot 4 arranged in the vicinity of the magnetic disc 3, and the suspension 6 is supported on the tip of the arm 5. The slider and the head 7 are arranged on the tip of the suspension 6. A coil is wound on the side of the proximal end of the arm 5 so as to form a part of the voice coil motor 9. The arm 5 is pivotally rotated around the pivot 4 by the voice coil motor 9. Writing information in the magnetic disc 3 and reading information from the magnetic disc 3 performed by a recording pole and a read element (e.g., a GMR element) included in the head 7 are controlled by the head IC 11 via the flexible printed circuit (FPC) 12. The head stopper includes the outer stopper 13 and the inner stopper 14.

During the operation of the magnetic disc apparatus, the magnetic disc 3 is rotated and the head 7 is loaded on the magnetic disc 3. Positioning of the head 7 is performed based on servo data written in the magnetic disc 3. However, where the head 7 is out of control due to failure in reading the servo data accurately, the head 7 may collide against the clamper 2 positioned at the inner circumferential of the magnetic disc 3. In order to avoid the problem, the voice coil motor 9 is made in contact with the inner stopper 14, as shown in FIG. 2, thereby limiting the movement of the head 7.

When the operation of the magnetic disc apparatus is stopped, the head 7 is unloaded onto a ramp 10 from a loading position on the magnetic disc 3. When the head 7 is moved away from the magnetic disc 3 in this stage, it is impossible to perform positioning of the head 7. Such being the situation, the voice coil motor 9 is made in contact with the outer stopper 13 as shown in FIG. 1, through supply of an appropriate current, thereby limiting the movement of the head 7.

The outer stopper 13 and the inner stopper 14 are fixed to the base 1 or a top yoke (not shown). Incidentally, the outer stopper 13 may be arranged so as to contact with the arm 5 or the tub 8.

Now, the reason why the outer stopper preferably exhibits rebound resilience not higher than 60 will be described. In a case of emergency unloading such that power supply is stopped when the head 7 is loaded on the disc 3, the voice coil motor 9 collides against the outer stopper 13. In this case, if the outer stopper 13 has high rebound resilience, the head 7 may possibly be rebounded by the counteraction to the collision of the voice coil motor 9 against the outer stopper 13 so as to be loaded again on the disc 3. This is because the unloading speed is set higher in the emergency unloading, in order to ensure the unloading of the head 7, than that in the ordinary unloading, with the result that greater rebound is brought about. However, since the disc 3 fails to be rotated if the power supply is cut off, the head 7 is stuck to the disc 3 when the head 7 is loaded again on the disc 3 under the particular situation. It follows that the disc 3 cannot be rotated even if it is attempted to operate the magnetic disc apparatus later. In order to avoid this problem, it is desirable to lower the rebound resilience of the outer stopper 13 to 60 or less.

The durability of the head stopper was studied under conditions of high temperature and high humidity by using the materials given below:

Polyester elastomer 1 [manufactured by Toyobo Co. Ltd., trade name: PELPRENE P-150B]

Polyester elastomer 2 [manufactured by Toyobo Co. Ltd., trade name: PELPRENE P-40H]

Styrene-ethylene-butylene-styrene block copolymer (SEBS) [manufactured by Aron Kasei Co., Ltd.]

Elastomer-added polyacetal [manufactured by Asahi Kasei Co., Ltd., trade name: TENAC-C T0212]

With respect to these materials, following characteristics were measured: (1) Percent tensile strength retained, (2) Deformation time, and (3) Rebound resilience. Measuring methods for these characteristics will be described below.

(1) Percent tensile strength retained: The tensile strength was measured in conformity with the method defined in ASTM D638 both before and after the material was left to stand under conditions of the temperature of 80° C. and the relative humidity of 85% for 1,500 hours. Then, the percent tensile strength retained was calculated based on the equation given below:

R=(T_{A}/T_{B})×100, where R is the percent tensile strength retained, T_{A} is the tensile strength after the material was left to stand under the above conditions, and T_{B} is the tensile strength before the material was left to stand under the above conditions.

(2) Deformation time: Each of the materials was shaped into an outer stopper and the outer stopper was attached to a magnetic disc apparatus. Then, load/unload operations of the head were performed under conditions of the temperature of 80° C. and the relative humidity of 85%. The shape of the outer stopper was observed every 200 hours so as to determine the time elapsed before any deformation such as liquefaction or crack occurrence is brought about. Each test was conducted until 3,000 hours of period of time at maximum was elapsed.

(3) Rebound resilience: The rebound resilience was measured under room temperature (25° C.) in conformity with the method defined in JIS K6255.

Table 1 shows the results.

TABLE 1

| | | | | Elastomer- |
|---|---|---|---|---|
| | Polyester | Polyester | | added |
| | elastomer 1 | elastomer 2 | SEBS | polyacetal |
| Number of moles of | 0.7 | 0.4 | 0.0 | 0.0 |
| hydrolyzable group | | | | |
| per 100 g of resin | | | | |
| [mole] | | | | |
| Percent tensile | 0* | 85 | 97 | 99 |
| strength retained | | | | |
| [%] | | | | |
| Deformation time | 1400 | >3000 | >3000 | >3000 |
| [h] | | | | |
| Rebound resilience | 59 | 78 | 43 | 42 |
| [%] | | | | |

*unmeasurable

The ester group contained in the polyester elastomer is lower in hydrolyzability than the urethane group contained in the conventional polyurethane. As a result, the head stopper formed of polyester elastomer exhibited durability not shorter than 1,000 hours under the temperature of 80° C. and the relative humidity of 85%.

As shown in Table 1, the amount of the hydrolyzable group per 100 g of the resin was 0.7 mole for the polyester elastomer 1 and 0.4 mole for the polyester elastomer 2. The polyester elastomer 2 has a molecular structure in which a smaller proportion of the ester component and a larger proportion of the elastomer component are contained, compared with the polyester elastomer 1. The head stopper formed of the polyester elastomer 1 was made brittle due to hydrolysis so as to be cracked easily after the head stopper was left to stand under the temperature of 80° C. and the relative humidity of 85% for 1,400 hours. On the other hand, the head stopper formed of the polyester elastomer 2 exhibited higher percent tensile strength retained than that for the head stopper formed of the-polyester elastomer 1 and improved deformation time exceeding 3,000 hours.

Each of the SEBS and the elastomer-added polyacetal is substantially free from the hydrolyzable group. Thus, the percent tensile strength retained was found to be 97 to 99%, which was further higher than that for the polyester elastomer 2 as well as the deformation time was found to exceed 3,000 hours. Therefore, it is suitable to use the SEBS or the elastomer-added polyacetal for forming the head stopper in the case where durability to severer conditions is required.

It should also be noted that the polyester elastomer 2, which has a large proportion of the elastomer component, exhibits rebound resilience exceeding 60. On the other hand, each of the SEBS and the elastomer-added polyacetal exhibits low rebound resilience of 42 to 43. Therefore, the SEBS and the elastomer-added polyacetal can be suitably used for forming the outer stopper.

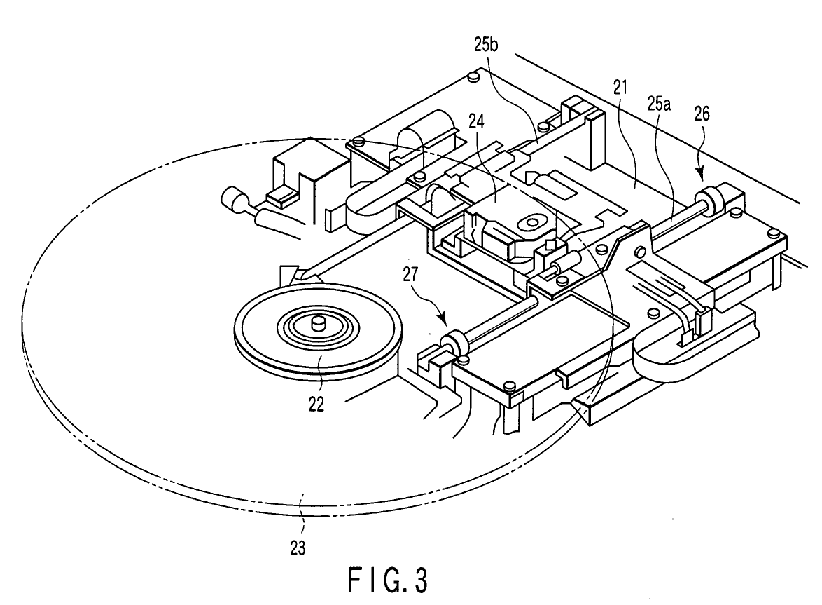

FIG. 3 is a perspective view showing the optical disc apparatus for an automobile use according to another embodiment of the present invention. The optical disc 23 is clamped with the damper 22 of a spindle motor mounted on the base 21. The head 24 including an optical system such as a light source and a lens is mounted so as to slide along the guides 25a and 25b. The outer stopper 26 and the inner stopper 27 for limiting the moving range of the head 24 is attached to one guide 25a.

Also in the optical disc apparatus shown in FIG. 3, when the outer and inner stoppers 26 and 27 are formed of a resin containing a hydrolyzable group in an amount not more than 0.7 mole per 100 g, e.g., a resin selected from the group consisting of a polyester elastomer, a styrene-ethylene-butylene-styrene block copolymer and an elastomer-added polyacetal, the stoppers 26 and 27 will exhibit excellent durability under an environment of a high temperature and a high humidity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A head stopper configured to limit a moving range of a head having a read element reading information from a recording medium, the head stopper being formed of a resin containing a hydrolyzable group in an amount not more than 0.7 mole of per 100 g.

2. The head stopper according to claim 1, wherein the head stopper is formed of a resin containing a hydrolyzable group in an amount not more than 0.05 mole of per 100 g.

3. The head stopper according to claim 1, wherein the resin is selected from the group consisting of a polyester elastomer, a styrene-ethylene-butylene-styrene block copolymer, and an elastomer-added polyacetal.

4. The head stopper according to claim 1, wherein the head stopper exhibits rebound resilience not higher than 60.

5. A magnetic disc apparatus, comprising:
a magnetic disc;
a head having a read element reading information from the magnetic disc; and
a head stopper configured to limit a moving range of the head and formed of a resin containing a hydrolyzable group in an amount not more than 0.7 mole per 100 g.

6. The magnetic disc apparatus according to claim 5, wherein the head stopper is formed of a resin containing a hydrolyzable group in an amount not more than 0.05 mole per 100 g.

7. The-magnetic disc apparatus according to claim 5, wherein the resin forming the head stopper is selected from the group consisting of a polyester elastomer, a styrene-ethylene-butylene-styrene block copolymer, and an elastomer-added polyacetal.

8. The magnetic disc apparatus according to claim 5, wherein the head stopper exhibits rebound resilience not higher than 60.

9. The magnetic disc apparatus according to claim 8, wherein the head stopper exhibiting the rebound resilience not higher than 60 is used as an outer stopper configured to limit movement of the head to an outer position across an unloading area from a loading position on the magnetic disc.

10. In-vehicle electronic equipment, comprising:
a head having a read element reading information from a disc recording medium; and
a head stopper configured to limit a moving range of the head and formed of a resin containing a hydrolyzable group in an amount not more than 0.7 mole per 100 g.

11. The equipment according to claim 10, wherein the head stopper is formed of a resin containing a hydrolyzable group in an amount not more than 0.05 mole per 100 g.

12. The equipment according to claim 10, wherein the resin forming the head stopper is selected from the group consisting of a polyester elastomer, a styrene-ethylene-butylene-styrene block copolymer, and an elastomer-added polyacetal.

13. The equipment according to claim 10, wherein the head stopper exhibits rebound resilience not higher than 60.
